(19) United States
(12) Patent Application Publication
(10) Pub. No.: US 2020/0117500 A1
(43) Pub. Date: Apr. 16, 2020

(54) METHOD FOR CONTROLLING A MULTI-CORE PROCESSOR AND ASSOCIATED COMPUTER

(71) Applicants: THALES, Courbevoie (FR); INRIA INSTITUT NATIONAL DE RECHERCHE EN INFORMATIQUE ET EN AUTOMATIQUE, Le Chesnay (FR); SORBONNE UNIVERSlTE, Paris (FR)

(72) Inventors: Cédric COURTAUD, Palaiseau (FR); Xavier JEAN, Palaiseau (FR); Madeleine FAUGERE, Palaiseau (FR); Gilles MULLER, Paris (FR); Julien SOPENA, Paris (FR); Julia LAWALL, Paris (FR)

(21) Appl. No.: 16/473,190

(22) PCT Filed: Dec. 26, 2017
(86) PCT No.: PCT/EP2017/084589

§ 371 Date: Jun. 24, 2019

(30) Foreign Application Priority Data
Dec. 26, 2016 (FR) 16/01859

(51) Int. Cl. G06F 9/46; G06F 9/52; G06F 9/50

(52) U.S. Cl. CPC G06F 9/466; G06F 9/5027; G06F 9/52

(57) ABSTRACT

The invention relates to a control method for a multi-core processor comprising a plurality of cores sharing at least one common material resource according to a sharing policy based on different time windows, each time window being attributed to least one core.

The control method comprises the anticipation of a request to be emitted by a software application run by a core and requiring a transaction between said core and the common resource, the planning of the transaction in a time window to be attributed said core for access to the common resource, the implementation of the planned transaction and the loading of the data into a private cache memory of said core, and the restitution of the data to the software application from the private cache memory.

### TECHNICAL FIELD

The invention targets the field of multi-core processor computers comprising several physically separate cores sharing common material resources.

### BACKGROUND OF THE INVENTION

Each core of a multi-core processor is a computing unit physically separate from the other cores. The presence of several cores allows the execution of several software applications in parallel, in order to offer better overall performance.

For the execution of the software applications, the cores use common material resources. These common resources are for example memories, in particular a main memory, an interconnect network, input/output interfaces (or I/O interface) of the computer (PCIe fast bus or Ethernet Network, for example) or an interconnect interface between the cores and these different common material resources.

The cores can simultaneously execute several software applications concurrently, each core executing one or several software applications. This concurrence causes uncertainty in the processing time of the data by the multi-core processor.

For example, when a main memory must respond to several transactions emitted by the software applications at the same time, it is common for the transactions to be processed sequentially, which causes delays in the execution of certain software applications. Such conflicts are called “interferences”.

From the perspective of the software application, the interferences slow down the response time of the common material resources, which in turn causes delays in the execution of the software application. These delays can constitute the majority of the execution time of the software application.

Yet the majority of on-board electronic systems like those used in the avionics field, the aerospace field or the railway field, need determinism in the duration of the processing times to satisfy certification constraints.

Another problem encountered in industry is that of the integration process of the computer and software applications provided to be executed by the computer, which is generally iterative. Interferences can appear during the iterative integration process, causing a sudden deterioration of the performance in a step of the integration process, calling the previous steps of the integration process into question.

### SUMMARY OF THE INVENTION

One aim of the invention is to propose a method for controlling a multi-core processor implementing an effective control method, allowing good use of the common material resources while providing a good level of determinism in the processing duration of the data.

To that end, the invention proposes a control method for a multi-core processor comprising several physically separate cores sharing at least one common material resource according to a sharing policy based on different time windows, each time window being attributed to at least one core for access to a common material resource, the control method comprising:
the anticipation of a request to be emitted by a software application run by a core and requiring a transaction between said core and the common resource, before the actual emission of this request by the software application;
the planning of the transaction in a future time window attributed to said core for access to the common resource;
the implementation of the planned transaction in the time window and the loading of the data into a private cache memory of said core; and
the restitution of the data to the software application from the private cache memory upon the actual emission of the request by the software application.

The control method may optionally comprise one or more of the following optional features, considered alone or according to any technically possible combination(s):
the core continues the execution of the software application from the private cache memory between the planning of the transaction and the implementation of the transaction;
the triggering of the anticipation and planning steps upon the emission of a system call by the software application;
the triggering of the anticipation and planning steps upon the triggering of a page fault caused by the emission of an emitted request requiring a transaction between said core and the common resource to serve the emitted request, the anticipated request being separate from the emitted request;
the anticipated request is planned after the emitted request;
the triggering of an exception caused by an emitted request by the software application;
the anticipation and planning steps are carried out by a software access controller configured for the implementation of the sharing policy of the common resources; and
the anticipated request is determined by detecting a sequence of preceding requests having required a transaction, and comparing the detected sequence of requests to predefined characteristic sequences of requests, each associated with a predefined anticipated request.

The invention also relates to a computer comprising a multi-core processor having several physically separate cores and at least one common material resource shared by the cores and accessible to the cores according to a sharing policy based on separate time windows, each time window being attributed to at least one core for the access to the common material resource, wherein at least one software access controller for the control of the transactions between a core and the common material resource and/or a software application implemented on the core are configured for the implementation of a control method as defined above.

### BRIEF DESCRIPTION OF THE DRAWINGS

The invention and its advantages will be better understood upon reading the following description, provided solely as an example, and done in reference to the appended drawings, in which:

FIG. 1 is a schematic view of a computer of an on-board avionics system, the computer comprising a multi-core processor having several cores sharing common resources;

FIGS. 2 to 4 are timelines illustrating time partitions for sharing of the common resources.

### DETAILED DESCRIPTION OF PREFERRED EMBODIMENTS

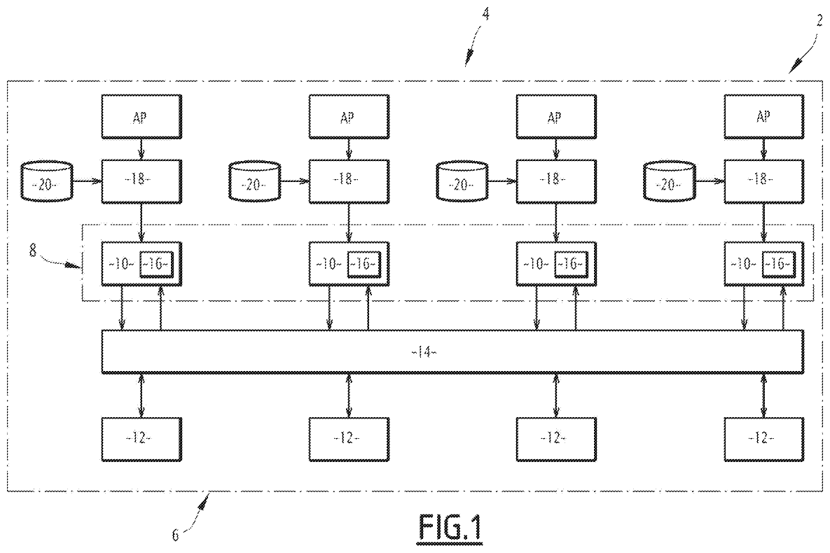

In FIG. 1, an avionics system 2 on board an aircraft 4 has a computer 6 having a multi-core processor 8 comprising several cores 10, common resources 12 shared by the cores 10, and an electronic interconnect 14 by means of which the cores 10 access the common resources 12.

The cores 10 are physically separate. Each core 10 is an individual computing unit comprising its own electronic components, separate from those of the other cores 10.

The common resources 12 are material resources shared by the cores 10. The common resources 12 are for example memories, such as a main memory, a shared cache memory (for example a level 2 memory called Cache L2 or level 3 called Cache L3), or input/output interfaces (or I/O interface). An input/output interface makes it possible to emit or receive signals on a communication bus (not shown), for example a communication bus of the avionics system for communication between several computers or between the computers and measuring probes or actuators.

The interconnect 14 is for example an interconnect bus. Preferably, all of the cores 10 of the processor 8 are connected to the common resources 12 by means of the same and single means formed by the interconnect 14.

Each core 10 is able to execute one or several useful software applications, preferably under the control of a computer operating system (OS), which is a specific software application executed by the core 10 and which controls the use of the software or hardware resources accessible to this core 10 (including the common resources 12) by the useful software applications. Hereinafter, the term “software application AP” refers to the useful software applications or the computer operating system executed by a core 10.

During its execution, a software application AP executed by a core 10 excites the core 10, which generates requests that are processed by the core 10. A request generally corresponds to a read or write request at a determined address of the addressable memory space.

Each core 10 has a private cache memory 16, which is used exclusively by this core 10, and which is physically integrated into the core 10. The private cache memory 16 is used to store data loaded from common resources 12 and which may potentially be requested by the software applications AP executed by the core 10.

If the data corresponding to a request emitted by a software application AP is present in the private cache memory 16, the request can be processed at the core 10 without generating access to the common memory 12.

If the data corresponding to a request emitted by a software application AP is not present in the private cache memory 16, the core 10 must perform a transaction with a common resource 12 to load the data and store a copy thereof in the private cache memory 16. Hereinafter, a “transaction” refers to an exchange of data between a determined core 10 and a determined common resource 12.

In one embodiment, each core 10 comprises a software access controller 18 to control the access by this core 10 to the common resources 12.

The access controller 18 is a software layer interposed between the applications executed by the core 10 (including an operating system executed by the core 10) and the core 10 itself. The access controller 18 is a computer program that comprises code instructions specific to this program. The access controller 18 is for example integrated into a hypervisor.

The core 10 executes its own access controller 18 locally, without calling on the common resources 12. The access controller 18 comprises code instructions that are stored entirely in the private cache memory 16 of the core 10 and are executable using only the private cache memory 16 of this core 10.

The private cache memory 16 of the core 10 has a sufficient capacity to execute the access controller 18. The execution of the access controller 18 by the core 10 therefore does not require the emission of transactions toward the common resource 12, which can interfere with the activity of the other cores 10 in the common resources 12.

The access controller 18 of each core 10 is configured to intercept each request sent to the core 10 by the software application AP executed by this core 10 and requiring a corresponding transaction by the core 10 toward the common resource 12, and to plan the transaction.

In one embodiment, the data stored in the private cache memory 16 is organized in data pages, and the core 10 is configured to trigger a page fault in case of absence of data associated with the request in the private cache memory 16.

The access controller 18 is then for example configured to be executed during a page fault triggered by the emission of a request from a software application AP executed by the core 10 targeting data not present in the private cache memory 16 of the core 10.

During the execution of the software applications AP by the cores 10, the cores 10 are in competition for the use of the common resources 12. Yet each transaction between a determined core 10 and a determined common resource 12 must be done with a limited time cost.

The sharing of common resources 12 by several cores 10 therefore requires defining a common resource sharing policy 12, i.e., a set of rules restricting the competing activity of the different cores 10 in the common resources 12.

The access controller 18 of each core 10 is configured to perform the necessary transactions by implementing the sharing policy of the common resources 12.

The control method implements a sharing policy of at least one common resource 12 based on separate time windows F, each time window F being allocated to one or several specific cores 10 for the access to the common resource 12. Only the cores 10 to which a time window F is attributed are authorized to access the common resource 12 during this time window F.

In one embodiment, each time window F is exclusively attributed to a single core 10. Thus, the requests emitted by the cores 10 to the common resources 12 will be temporally isolated. This sharing policy for the material resources is of the time division multiple access (TDMA) type. In a variant, at least one time window F is allocated to several cores 10.

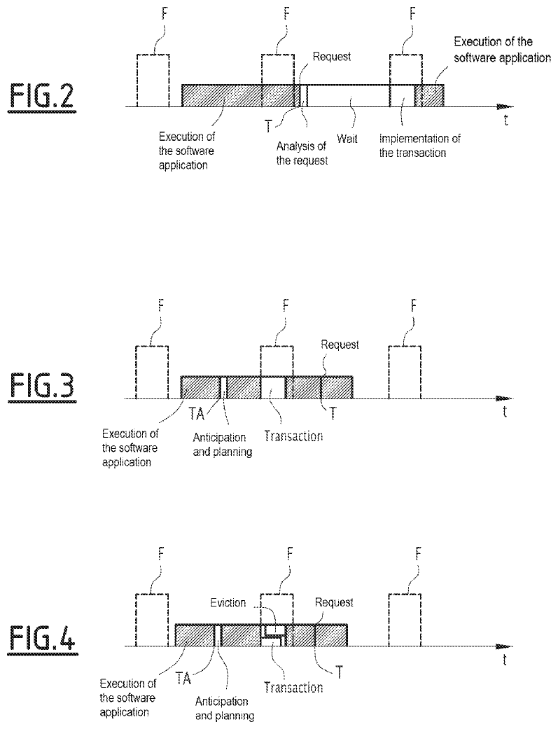

FIG. 2 illustrates a control method according to the prior art.

Time windows F are attributed to a core 10 for access to a common resource 12.

The cross-hatched periods correspond to the execution of the software application AP by the core 10 from the private cache memory 16, and the intermediate white periods correspond to interruptions of the execution of the software application AP, when a datum is not available in the private cache memory 16.

A software application AP is executed by default from the private cache memory 16 of the core 10 (first crosshatched period in FIG. 2). The software application AP emits requests during operation that are served from the private cache memory 16.

At a moment T, the software application AP emits a request to access data that is not available in the private cache memory 16 and that therefore requires a transaction between the core 10 and the common resource 12 to load this data into the private cache memory 16 and to restitute this data for the software application AP.

The request is emitted at a moment T located outside a time window F attributed to the core 10 for the access to the common resource 12. The core 10 must then analyze the request, wait for the next time window F attributed to the core 10 for access to the common resource 12 to perform the transaction with the common resource 12, and recover the data corresponding to the request from the software application AP (white periods in FIG. 2).

Once the data is recovered and loaded in the private cache memory 16, the execution of the software application AP from the private cache memory 16 resumes (second crosshatched period in FIG. 2).

The execution of the software application AP is interrupted during the analysis of the request, the waiting for the next time window F and the implementation of the transaction. The duration between the emission of the request by the software application AP and the restitution of the data for the software application AP comprises the analysis duration of the request, the waiting duration for the next time window F attributed to the core 10 for access to the common resource 12 and the duration of the transaction. The waiting duration for a time window F can constitute the majority of the execution time for a software application. The control method described here is deterministic, but ineffective.

The control method according to the invention, illustrated in FIG. 3, aims to optimize the access time to at least one common resource 12. It allows the use of certain time windows F in phase advance—and without waiting duration—relative to the execution of the software application AP.

The control method comprises:
the anticipation of a request to be emitted by a software application AP run by the core 10 and requiring a transaction with the common resource 12, before the actual emission of this request by the software application AP;
the planning of the transaction in a future time window F attributed to the core 10 for access to the common resource 12 and in which no transaction is planned;
the implementation of the planned transaction in the time window F and the loading of the data into the private cache memory 16 of the core 10; and
the restitution of the data to the software application AP from the private cache memory 16 upon the actual emission of the request by the software application AP.

Preferably, the transaction is planned in a free time window F, in which no transaction has yet been planned.

It is desirable for the transaction to be planned in a time window F that is prior to the actual emission of the request by the software application AP. Preferably, the transaction is planned in the next free time window F, in which no transaction has yet been planned.

As illustrated in FIG. 3, the anticipation of the request at a moment TA situated before a time window F unused by the core 10 to access the common resource 12 makes it possible to load the data in the private cache memory 16 during a time window F that would have remained unused by the core 10, and the restitution of the data for the execution of the software application upon the actual emission of the request by the software application AP, at the moment T of emission of the request.

Furthermore, as illustrated in FIG. 3, the transaction is planned when the emission of the request is anticipated, and the execution of the software application AP by the core 10 from the private cache memory 16 is continued between the planning and the time window F during which the transaction is planned. Given that the transaction is anticipated and is not yet necessary for the execution of the software application AP, the execution of the software application AP can be continued.

The data is then available as of the actual emission of the request by the software application AP. As a result, the execution duration of the software application AP is greatly reduced. Thus, as illustrated in FIG. 3, the restitution of the data is done immediately after the emission of the request by the software application AP.

Optionally, as illustrated in FIG. 4, the control method comprises the eviction of the data from the private cache memory 16 during the time window F during which the anticipated transaction is done. The data eviction is a write transaction for the data evicted from the private cache memory 16 in the common resource 12. This evicted data has optionally been modified in the meanwhile by the software application AP.

This makes it possible to best use the time window F that would have remained unused by the core 10 in order to access the common resource by avoiding waiting for a time window F during the emission of the request by the software application AP.

In one embodiment, the core 10 comprises a software access controller 18 to control the access by this core 10 to the common resource 12. The access controller 18 is a software layer interposed between the applications executed by the core 10 (including an operating system executed by the core 10) and the core 10 itself. The access controller 18 is a computer program that comprises code instructions specific to this program. The access controller 18 is for example a hypervisor.

The core 10 executes its own access controller 18 locally, without calling on the common resource 12. The access controller 18 comprises code instructions that are stored entirely in the private cache memory 16 of the core 10 and are executable using only the private cache memory 16 of this core 10.

The private cache memory 16 of the core 10 has a sufficient capacity to execute the access controller 18. The execution of the access controller 18 by the core 10 therefore does not require the emission of transactions toward the common resource 12, which can interfere with the activity of the other cores 10 in the common resources 12.

The access controller 18 of each core 10 is configured to intercept each request sent to the core 10 by the software application AP executed by this core 10 leading to the potential emission of a corresponding transaction by the core 10 toward the common resource 12, and, if applicable, to command the emission of the transaction in a time window F attributed to the core 10 for the access to the common resource 12.

The access controller 18 of the core 10 is configured to implement the sharing policy of the common resources 12.

For the implementation of the control method, it is appropriate, on the one hand, to trigger the anticipation and planning steps at the appropriate moment during the execution of the software application AP, and, on the other hand, to determine an anticipated request and to plan the transaction in a free allocated window.

In one embodiment, the software application AP is configured to emit a hypercall to trigger the anticipation and planning steps, in a determined step of the execution of the software application AP. The code of the software application AP is modified to integrate a hypercall making it possible to trigger the anticipation and planning steps.

The emission of the hypercall interrupts the execution of the software application AP and triggers the execution of the access controller 18.

The access controller 18 is configured to determine an anticipated request able to be emitted imminently by the software application AP and requiring a transaction with the common resource 12, and to plan the transaction in a free time window F.

This embodiment makes it possible to program each software application AP specifically to trigger anticipation and planning steps, at a moment of the execution of the software application AP that is particularly appropriate for this software application AP.

In a variant, the anticipation and planning steps are triggered during the triggering of a page fault caused by a first request emitted by the software application AP.

Indeed, in case of page fault, the core 10 interrupts the execution of the software application AP and the access controller 18 is activated to perform the loading transaction of the data of the first request having triggered the page fault.

The access controller 18 is configured to determine a second anticipated request able to be emitted imminently by the software application AP and requiring a transaction with the common resource 12, and to plan the transaction of the second request in a free time window F. The anticipated second request is of course different from the emitted first request that triggered the page fault.

In this embodiment, the transaction of the emitted first request having triggered the page fault will be done in the next free time window F, and the transaction of the anticipated second request will be planned in another later free time window F so as not to delay the transaction related to the emitted first request and having triggered the page fault.

This embodiment makes it possible to avoid modifying the code of the software applications executed by the core 10, and is applicable to any software application AP executed by the core 10.

Optionally, the anticipation step is triggered by an “exception” requested by the software application AP during its execution. An exception is an exceptional situation resulting from the execution of the software application AP and requiring an interruption of the execution of the software application AP.

The accounting for exceptions triggered by the execution of the software application AP makes it possible to trigger the anticipation step most frequently to improve the performance of the multi-core processor by anticipating future requests requiring a transaction.

In the different embodiments, the access controller 18 is configured to determine an anticipated request that may be emitted later by the software application AP.

To that end, the access controller 18 is for example configured to record traces of transactions done for the software application AP, and to determine an anticipated request as a function of the transactions done previously for the software application AP.

The access controller 18 for example comprises a software logic controller configured to determine an anticipated request as a function of the transactions done previously for the software application AP.

To predict a request, it is possible to perform profiling of the requests from the software application AP.

Such profiling for example makes it possible to determine request tables 20 associating sequences of characteristic requests with likely associated requests. Thus, if a characteristic sequence of requests is detected, the anticipated request is determined as being the likely request associated with the characteristic sequence of requests.

The profiling of the requests of a software application AP is done during one or several executions of the software application AP, by simulation of the operation of the software application AP and/or by static analysis of the software application AP.

The control method is implemented on one or several cores 10 and for the sharing of one or several common resources 12. Each core 10 implementing the control method can be configured independently to implement anticipation and planning steps.

In the case of several common resources 12, it is possible to consider determining a sharing policy for the common resources 12 according to which each time window F is attributed to a single core 10 in order to access all of the common resources 12.

In a variant, it is possible to consider determining a sharing policy for the common resources 12 according to which at least one same time window F is attributed to a first core 10 for a first common resource 12 and to a second core 10 different from the first core 10 for a second common resource 12 different from the first common resource 12. This is possible if the first and second cores 10 are not in competition for the first and second common resources 12.

The control method according to the invention therefore makes it possible to decrease the execution time of software applications on a multi-core processor incorporating an access controller 18, by performing transactions in phase advance, by predicting or anticipating requests requiring a transaction and performing the transaction in advance, before the actual emission of the request by the software application.

The control method is applicable in particular to a computer of an avionics system as previously described. It is more generally applicable to any computer, in particular a computer requiring processing of requests from software applications in a limited time. It is in particular applicable to a computer on board an avionics system, an aerospace system or a railway system.

1. A control method for a multi-core processor comprising several physically separate cores sharing at least one common material resource according to a sharing policy based on different time windows, each time window being attributed to at least one core for access to a common material resource, the control method comprising:
the anticipation of a request to be emitted by a software application run by a core and requiring a transaction between said core and the common resource, before the actual emission of this request by the software application;
the planning of the transaction in a future time window attributed to said core for access to the common resource;
the implementation of the planned transaction in the time window and the loading of the data into a private cache memory of said core; and
the restitution of the data to the software application from the private cache memory (16) upon the actual emission of the request by the software application.

2. The control method according to claim 1, wherein continues the execution of the software application from the private cache memory between the planning of the transaction and the implementation of the transaction.

3. The control method according to claim 1, comprising, triggering of the anticipation and planning steps upon the emission of a system call by the software application.

4. The control method according to claim 1, comprising the triggering of the anticipation and planning steps upon the triggering of a page fault caused by the emission of an emitted request requiring a transaction between said core and the common resource to serve the emitted request, the anticipated request being separate from the emitted request.

5. The control method according to claim 1, wherein the anticipated request is planned after the emitted request.

6. The control method according to claim 1, comprising the triggering of an exception caused by an emitted request by, the software application.

7. The control method according to claim 1, wherein the anticipation and planning steps are carried out by a software access controller configured for the implementation of the sharing policy of the common, resources.

8. The control method according to claim 1, wherein the anticipated request is determined by detecting a sequence of preceding requests having required a transaction, and comparing the detected sequence requests to predefined characteristic sequences of requests, each associated with a predefined anticipated request.

9. A computer comprising a multi-core processor having several physically separate cores and at least one common material resource shared by, the cores and accessible to the cores according to a sharing policy based on separate time windows, each time window being attributed to at least one core for the access to the common material resource, wherein at least one software access controller for the control of the transactions between a core and the common material resource and/or a software application implemented on the core are configured for the implementation of a control method according to claim 1.
